(19) United States
(12) Patent Application Publication
(10) Pub. No.: US 2005/0091155 A1
(43) Pub. Date: Apr. 28, 2005

(54) Payment distribution method for online product/service providers

(75) Inventor: Sundari Pokta, Tuen Mun (HK)

Correspondence Address: LEYDIG VOIT & MAYER, LTD, 700 THIRTEENTH ST. NW, SUITE 300, WASHINGTON, DC, 20005-3960, US

(73) Assignee: Cratexious Limited, Tsuen Wan (HK)

(21) Appl. No.: 10/689,591

(22) Filed: Oct. 22, 2003

(51) Int. Cl. G06F 17/60

(52) U.S. Cl. 705/40

(57) ABSTRACT

A payment distribution method for distributing payment to a plurality of product/service providers of a fixed fee paid by a user using their products/services by means of a network access device on an electronic network over a fixed billing period. The method comprises the steps of: (1) setting up a system server and running a system program on the server; (2) installing and running a client program on the user's network access device; (3) recording data of usage of products/services by the user, comprising at least one of the following usage elements: size of files accessed, number of files accessed, time spent on providers' sites, duration of download processes and number of download transmissions; (4) calculating payment distribution to those providers provided products/services to the user over the billing period by dividing the user's fee into shares among them generally according to the usage element associated with each provider in relation to the total usage element associated with all providers; and (5) Distributing calculated payments to the providers.

The present invention relates to a payment distribution method for distributing payment to product and service providers based on a fixed fee paid by each user over a certain period.

### BACKGROUND OF THE INVENTION

After years of free access, Internet users have become too spoiled to pay for content or any Internet services. They will look for other free web sites once a site starts to charge for its content. Due to stiff competition and the need for advertisement revenue, many web sites are still offering free contents painfully. Web sites which started paid access made the wrong assumption that, one day almost all web sites will become fee-based and users will be willing to pay. However, if a user were to pay for every web site they frequently visit, the cost will be ridiculously high and the inconveniences incurred will fend off users. Even users who are willing to pay will only pay for a few sites that they find absolutely essential, and there are not many “essential” sites around. Hence, free and fee-based content providers will ultimately fail to generate enough profit to survive. Internet users will in turn lose most of the conveniences and benefits they currently enjoy.

The invention seeks to mitigate or at least alleviate such a problem by providing a distributive payment method that allows a user to obtain unlimited access to products and services from multiple providers based on a fixed payment.

The invention aims to offer a service to allow access to a large number of product/service providers with a single low fee per user, thereby stimulating a large number of users to pay for online contents (products) and services. The object is primarily to ease online content providers' struggle to acquire and keep paid users and to encourage online users who are willing to pay to obtain contents and services from a very large number of providers, at a low fixed fee. The succeeding objective is to provide a very profitable and price-worthy environment for providers and users.

### SUMMARY OF THE INVENTION

According to the invention, there is provided a payment distribution method for distributing payment to a plurality of product/service providers of a predetermined fee paid by a user using their products/services by means of a network access device on an electronic network over a predetermined billing period, comprising the steps of:
(1) setting up a system server and running a system program on the server;
(2) installing and running a client program on said user's network access device;
(3) recording data of usage of said products/services by said user, the data comprising at least one of the following usage elements: size of files accessed, number of files accessed, time spent on providers' sites, duration of download processes and number of download transmissions;
(4) calculating payment distribution to those providers provided products/services to said user over the billing period by dividing the user's fee into shares among them generally according to the usage element associated with each provider in relation to the total usage element associated with all providers; and
(5) Distributing calculated payments to said providers. Preferably, step (3) comprises recording the usage data on said network access device, if said user uses said products/services bypassing the system server.

Preferably, step (3) comprises recording the usage data on the system server, if said user uses said products/services via the system server.

It is preferred that in step (3) the usage data is recorded on either one or both of the system server and the network access device, and step (3) includes consolidating the usage data recorded on the system server and the network access device to generate total usage data for calculation in step (4).

It is further preferred that in step (3) the usage data is recorded on both the system server and the network access device, and the usage data is consolidated by the network access device, and in step (4) the payment distribution is calculated by the network access device.

It is further preferred that in step (3) the usage data is recorded on the network access device, and in step (4) the payment distribution is calculated by the network access device.

It is further preferred that in step (3) the usage data is recorded on both the system server and the network access device, and the usage data is consolidated by the system server, and in step (4) the payment distribution is calculated by the system server.

Preferably, the distributed payments sum up substantially to the user's fee.

In a preferred embodiment, in step (4) the payment distribution is calculated using the follow formula:

$${P}_{i} = ( \frac{{x}_{i}}{X} ) {f}_{0} where {\sum }_{alli}^{} \frac{{x}_{i}}{X} = 1$$

fₒ=Predetermined fee paid by user
Pᵢ=Payment for distribution to provider i
xᵢ=Usage element of use by user for provider i
X=Usage element of use by user for all providers

More preferably, the formula is generalized to:

$${P}_{i} = ( {w}_{1} \frac{{x}_{i , 1}}{{X}_{1}} + {w}_{2} \frac{{x}_{1 , 2}}{{X}_{2}} + … + {w}_{j} \frac{{x}_{i , j}}{{X}_{j}} ) {f}_{0}$$

$$Where {\sum }_{allj}^{} {w}_{j} = 1 , {\sum }_{alli}^{} \frac{{x}_{i , j}}{{X}_{j}} = 1$$

x_{i,1} and X₁=size of files accessed from provider i and all providers respectively
x_{i,2} and X₂=number of files accessed from provider i and all providers respectively
x_{i,3} and X₃=time spent on sites of provider i and all providers respectively
x_{i,4} and X₄=duration of download processes from provider i and all providers respectively
x_{i,5} and X₅=number of download transmissions from provider i and all providers respectively
wⱼ=weighing factor ranging from 0 to 1 inclusive.

In a preferred embodiment, a plurality of said users are involved, with step (3) and step (4) taken for each of them, and step (4) includes subsequently integrating the calculated payments in relation to all the users.

More preferably, in step (4) the calculated payments are integrated by the system server, and in step (5) the payments are distributed by the system server.

It is preferred that in step (3) the usage data is consolidated by the network access device during a predetermined interval following the billing period.

It is preferred that a plurality of said users are involved, with step (3) and step (4) taken for each of them, and step (4) includes subsequently transmitting the calculated payment distributions from the network access devices to the system server for integration thereby before taking step (5).

It is further preferred that in step (4) the calculated payment distributions are transmitted from the network access devices to the system server over a predetermined interval following the billing period.

It is yet further preferred that in step (3) the usage data is consolidated by the network access device during the same predetermined interval as that of step (4).

Preferably, a plurality of said users are involved, with step (3) and step (4) taken for each of them, and step (4) includes subsequently transmitting the calculated payment distributions from the network access devices to the system server for integration thereby before taking step (5).

More preferably, in step (4) the calculated payment distributions are transmitted from the network access devices to the system server over a predetermined interval following the billing period.

Advantageously, step (5) includes neglecting some of said providers of smallest shares in the calculated payment distribution.

More advantageously, step (5) includes setting a maximum number of providers per payment distribution in descending order of their shares to neglect those providers in excess of the number.

More advantageously, step (5) includes setting a minimum cut-off share percentage to neglect those providers of shares smaller than the cut-off percentage.

Preferably, the payment distribution method includes the following step between step (2) and step (3):
(2A) registering each of said provider and user participating in the method and setting up an individual account therefor.

More preferably, the payment distribution method is set up and operated by a system operator and run by a business operator who is only responsible for taking step (2A) and step (5).

### BRIEF DESCRIPTION OF DRAWINGS

The invention will now be more particularly described, by way of example only, with reference to the accompanying drawings, in which:

FIG. 1 is a schematic diagram showing a network connecting product/service providers, users and a system central site based on an embodiment of a payment distribution method in accordance with the invention;

FIG. 2 is a schematic diagram illustrating a user connecting to a provider of FIG. 1 via the central site using Method 1;

FIG. 3 is a schematic diagram illustrating a user connecting to a provider of FIG. 1 and to the central site using Method 2;

FIG. 2A is a schematic diagram equivalent to FIG. 2, showing more users and providers;

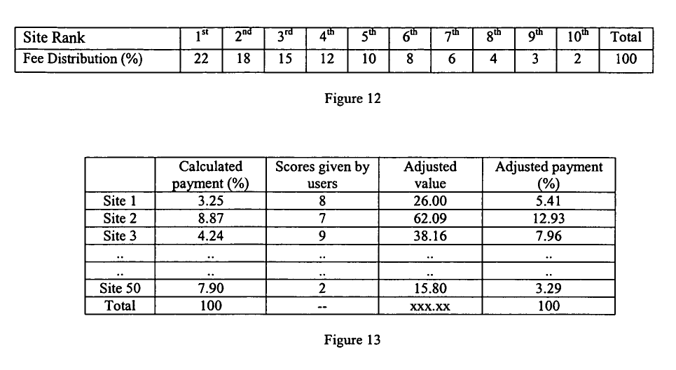

FIG. 3A is a schematic diagram equivalent to FIG. 3, showing more users and providers;

FIG. 4 is a schematic diagram of timeline on processing payment;

FIG. 5 is a table representing a provider database complied by a business operator of the subject invention;

FIG. 6 is a table representing a user database complied by the business operator;

FIG. 7 is a table representing a list of online users;

FIG. 8 shows a usage table for a specific user;

FIG. 9 shows a usage report built from the usage table of FIG. 8;

FIG. 10 shows a payment distribution table simplified from the usage report of FIG. 9;

FIG. 11 shows a payment table that is integrated from the payment distribution tables of the users, for distributing payments to the providers;

FIG. 12 is a table based on a ranking scheme for adjusting the payment distribution; and

FIG. 13 is a table based on a scoring scheme for adjusting the payment distribution.

### DETAILED DESCRIPTION OF PREFERRED EMBODIMENT

Referring to the drawings, there is shown a payment distribution method embodying the invention for the provision of products/services over an electronic network, which allows a user to obtain access to multiple product and service providers for a fixed subscription fee, regardless of the usage volume. The user's fee is to be distributed to the providers who granted access to the user primarily based on the usage and/or other criteria. The payment system utilising this payment method caters for a very large number of users and providers.

The payment system is set up and operated by a system operator, whereas the payment scheme is preferably run by a business operator who is not involved in the technical operation of the system. The business operator may be a financial institution who is expert in commerce. To join the scheme, both providers and users must first set up respective accounts with the business operator. Each user is required to pay the business operator a fixed subscription fee, for example on a monthly basis. The business operator then passes the databases of both the providers and the users as shown in the tables of FIGS. 5 and 6 to the system operator for installation. Management of the providers and users, including addition and removal thereof, is handled by the business operator, and the system operator updates the member lists accordingly.

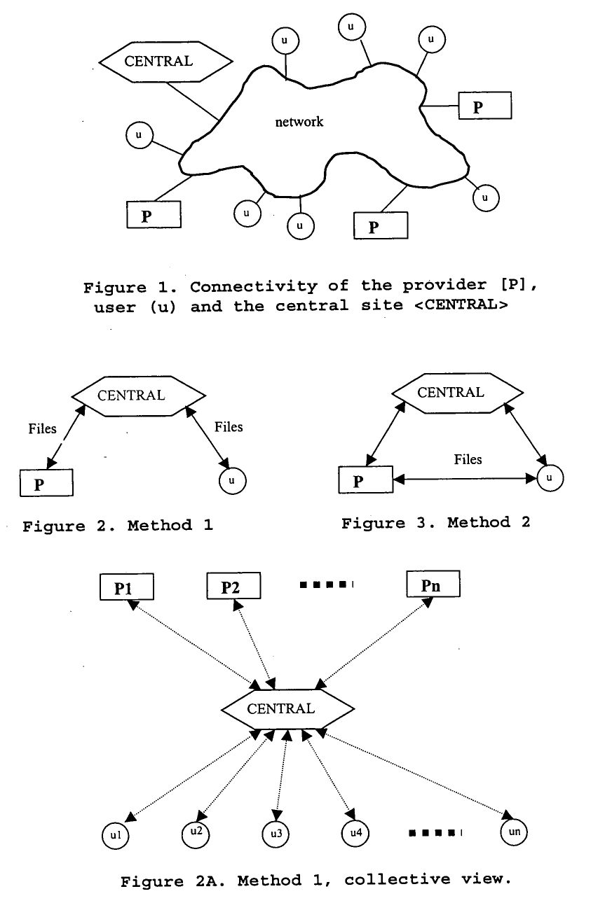

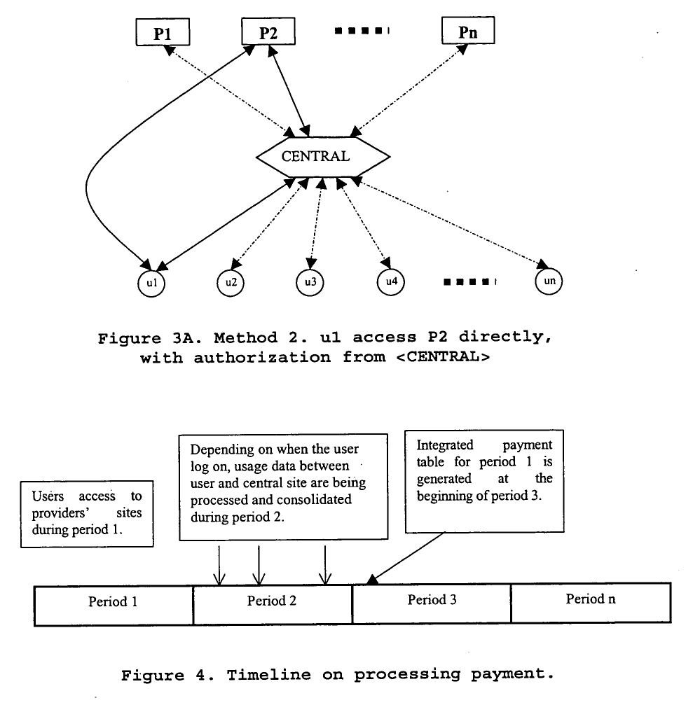

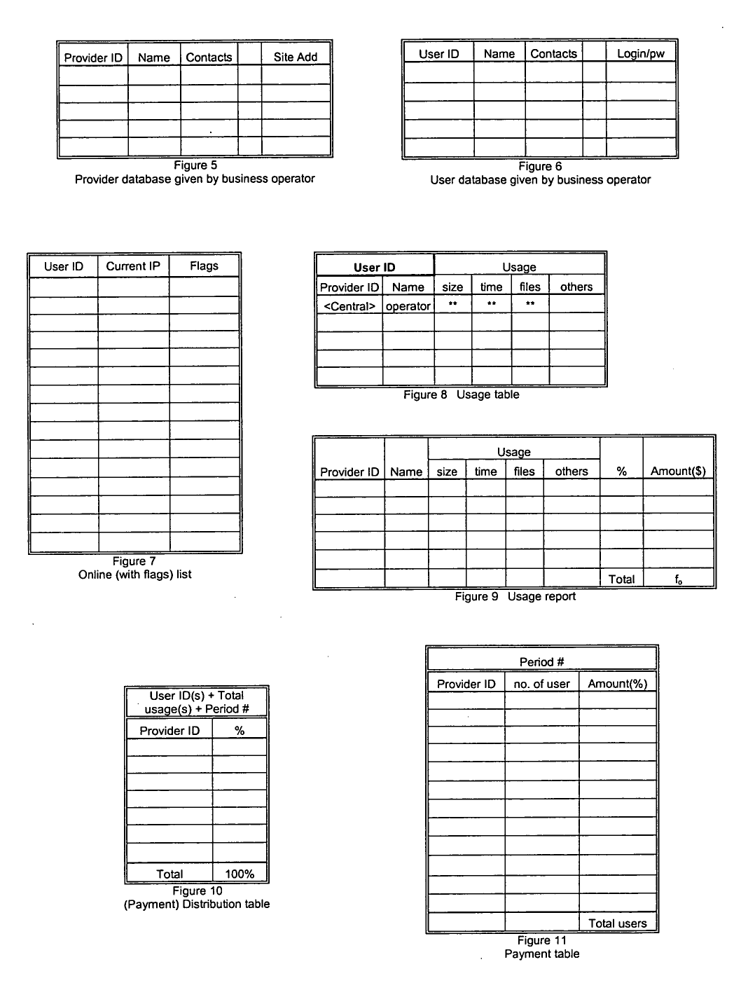

The applicable environment should be a set up in the form of an electronic network, with which the providers, the users and a central site incorporating a server of the system have direct or routed connectivity to all parties as shown in FIG. 1. The network can be any existing electronic network and is in particular the Internet.

Other feasible networks include, but not limited to, LAN, wireless LAN, WAN, cable network, mobile/cellular network, proprietary electronic network and telephone network.

Given that the business operator and the system operator may not be the same entity or within the same functional body, there is no need for the business operator to be connected to the network.

Based on the provider database supplied by the business operator, the system operator sets up a list of providers with their IDs and IP network addresses. The providers will be given a specific short program code (or html tag) to insert into each page (or file) chosen to be included in the payment system. Depending on the providers' server type, a server add-on program may be required upon initial set up.

According to the user database from the business operator, the system operator sets up particulars of the users and then waits for the users to log in and register. The users are required to install a client program on their computers, or any other network access devices such as PDAs or mobile phones. After installation, when the user's computer is online, the client program will register with the system central site for login ID, password, user ID and so on. A cookie is also written on his/her computer. This program is needed for accessing the providers' sites from the user's computer, and it also tracks the user's usage for payment processing. Each computer may register more than one user.

Physically, the system comprises the system central site on the network, client programs installed on the user computers and short program codes to be inserted to the pages on the providers' sites. In terms of function, the system comprises two main parts, namely access control and payment processing.

### Access Control

Once the set up is completed, users have two ways to gain access to the providers' products and services.

Method 1: Access from the Central Site

The users log on to the central site and access contents and services of the providers as shown in FIG. 2. As all the transmissions are channeled through the central site, the usage by the users can be recorded on the central site. Collectively, FIG. 2A shows how users gain access to the providers' sites via the central site. This method is relatively slower in connection and requires login procedures, and the users may be exposed to advertisements from central site.

Method 2: Access from the User's Computer

Each user accesses the providers' sites with the aid from the client program installed on his/her computer. When the user gets online, the program will transmit the account information (or cookie) from the computer to the central site as shown in FIG. 3. The central site will then verify the user's information and enlist the user's current IP address on the server for authorization purpose as shown in FIG. 7. This is similar to how instant messengers, such as icq, yahoo, msn, keep a list of online users. When the user requests to access a provider's site, the server of the provider will check the IP address of the requesting user against the list of IP addresses kept on the central site. Access will be granted upon successful verification. FIG. 3A is a collective view showing Method 2, which is different from Method 1.

Method 2 may have some variations in the actual implementation, in that in addition to the steps described above there are at least two possible alternative ways to make access efficient.

As the first alternative, the user issues a request for files to the central site instead of to the provider, and then the central site authenticates and passes the request on to the provider, and finally the provider serves the request (sending files) to the user direct. This can be visualized from FIG. 3, with the relevant data flowing in the anti-clockwise direction, i.e. initially from the user to the central site and then from the central site to the provider and finally from the provider back to the user.

As the second alternative, the user issues a request for files directly to the provider and informs the central site at the same time. In response, the central site authenticates and confirms to the provider, who then in turn serves the request (sending files) to the user direct. As can be visualized from FIG. 3, in comparison with the first alternative, the data flow between the user and the provider is bi-directional, i.e. initially from the user to the provider for request and finally from the provider back to the user for file transfer.

In both alternatives, the important step lies in the direct provision of products and/or services from the provider to the user.

The ease and simplicity of user authentication and, more importantly, the direct provision of products and services from the providers to the users bypassing the system operator are advantageous. This will relieve the system server from processing the load that can be shared by and should more suitably be handled directly by the two parties involved.

### Payment Processing

The client program also records the usage data on the user's computer. As users may access the products and services from home and public terminals, they are likely to use both Method 1 and Method 2 at different times for access as desired. At the end of each billing period, usage data from both sides will be consolidated when each user's computer goes online. Payment distribution to the providers from each user will be generated, and the system will integrate all sub-payments to produce a total payment table for use by the business operator.

To cater for the large number of providers and users, the users' computers will be required to meter usage and handle some payment processing work. The payment processing are divided into two parts, namely calculation and distribution.

### Payment Calculation

To fairly split or divide the user subscription fees among the various providers, the measurement of usage has to be made as accurate as possible.

Given that usage through an electronic network is not limited to merely typical content provision, a general usage formula is defined to cover most of the existing forms of electronic products and services available on the Internet.

Examples of the products and services available online are program files, news in different formats, audio, videos, weather, web-casts, real-time radio casts, calendars, e-cards, comics, games, chats (text, voice and video), albums, event organizations, auctions, e-mails, file storage, music, animations, dictionaries, spell checking, translations, faxes, messaging, communications, message boards, classifieds, financial quotes and functions, business and personal matching, and searches, etc.

The value of products and services provided by a provider can be measured or priced according to the size of files accessed, the number of files accessed, the time spent on the provider's site, the duration of download processes and the number of download transmissions, and any other elements (parameters or criteria) as required.

When usage is measured for text based products such as news, a reasonable usage element is the file size. Therefore, if only file size is considered for pricing the content, the fair share of payment that a content provider obtains from a particular user is:

$${P}_{i} = ( \frac{{x}_{i}}{X} ) {f}_{0} where {\sum }_{alli}^{} \frac{{x}_{i}}{X} = 1$$

fₒ=Fixed fee paid by user
Pᵢ=Payment to be received by provider i
xᵢ=Size of text files accessed by user from provider i
X=Size of text files accessed by user from all providers.

When usage is measured for a combination of products and services, a reasonable calculation for the share of payment that a provider obtains from a particular user is calculated as:

$${P}_{i} = ( \frac{{x}_{i , 1}}{{X}_{1}} + \frac{{x}_{i , 2}}{{X}_{2}} + \frac{{x}_{i , 3}}{{X}_{3}} + \frac{{x}_{i , 4}}{{X}_{4}} + \frac{{x}_{i , 5}}{{X}_{5}} ) \frac{{f}_{0}}{5} where {\sum }_{alli}^{} \frac{{x}_{i , j}}{{X}_{j}} = 1$$

x_{i,1} and X₁=size of files accessed from provider i and all providers respectively
x_{i,2} and X₂=number of files accessed from provider i and all providers respectively
x_{i,3} and X₃=time spent on sites of provider i and all providers respectively
x_{i,4} and X₄=duration of download processes from provider i and all providers respectively
x_{i,5} and X₅=number of download transmissions from provider i and all providers respectively.

A fair payment distribution should not be confined to usage measurement based on the five elements referred to above. Reasonable pricing of products and services may be measured by an arbitrary number of usage elements, and should be dependent on application.

To fairly distribute the subscription fees paid by the users, different usage elements may be of different levels of importance. For example, a payment scheme for web radio would consider the time spent to be the most appropriate usage element for measurement. On the other hand, a payment scheme for news would take the size of text files as the most appropriate usage element for measurement.

Accordingly, each usage element should be weighted for different payment schemes, and ultimate general formula is:

$${P}_{i} = ( {w}_{1} \frac{{x}_{i , 1}}{{X}_{1}} + {w}_{2} \frac{{x}_{1 , 2}}{{X}_{2}} + … + {w}_{j} \frac{{x}_{i , j}}{{X}_{j}} ) {f}_{0}$$

$$Where {\sum }_{allj}^{} {w}_{j} = 1 , {\sum }_{alli}^{} \frac{{x}_{i , j}}{{X}_{j}} = 1.$$

Assigning w₁ as “1” and the other weights to “0” will reduce the general formula to the first equation.

Each wᵢ may be predefined upon subscription or be defined by a user later.

Additional or alternative elements or criteria according to preferences of the users, such as ranking, scoring and rejection choice, etc. may be instrumented to adjust the distribution of their subscriptions to the providers.

This will allow the users (customers) to take an active part in determining how their fees are spent.

As an add-on module to the client program, the users may choose to use a ranking scheme to distribute the subscription fees instead of calculating the distribution based on relative usage. According to the scheme, each user may choose to rank his/her top 10 provider sites, and the fee distribution may be preset as shown in the table of FIG. 12. Some users may like to get involved in determining the quality of the providers' sites by assigning a score to adjust the payment. For example, a user might like to allocate a score to each of the websites for subscription distribution in favour of his/her preference. If a user is to assign a score from 1 to 10, an adjusted payment distribution may look as shown in the table of FIG. 13. In this example, payment to the sites with higher scores will be boosted by the user at the expense of the other sites. Some payment conscious users might want to prevent some unwelcome websites, for example by reason of offensive materials, intensive advertisements, slow response, misleading or defamatory contents or inaccurate results etc., from receiving their money. A choice may be given to them to reject a few websites from obtaining payment. This option will cause re-adjustment of the fee distribution to the other providers. There may be other more complicated schemes like voting from users, or scoring from professional reviewers, which introduce external elements (not from user) into the adjustment factors.

### Payment Distribution

When the users access the provider sites using Method 1, all predefined usage elements are being logged and aggregated on the central site. It should be noted that the usage elements like file sizes, and not the actual files, are being recorded. The usage elements are recorded as shown in the usage table of FIG. 8. When the users access the provider sites using Method 2, the same set of usage elements as in FIG. 8 are being logged and aggregated on the users' computers.

At the end of the first billing period 1, the client programs on the users' computers will request usage data (FIG. 8) from the system central site. Consolidated with its own usage table, each program will generate a usage report over that period for the respective user, which will include usage summary and calculated payment distribution as shown in FIG. 9.

Since the central site will provide the resources to record usage when the user accesses the provider sites using Method 1, the system operator may charge the user for a reasonable value(s) against the appropriate usage element(s) in the usage table of FIG. 8. More specifically, the system operator becomes one of the service providers and will charge a service fee by posting a usage value in the usage table (FIG. 8), which will eventually become a payment value in the distribution table (FIG. 10).

The payment system preferably presets a maximum number of providers per payment distribution (e.g. 50) in the distribution table of FIG. 10 in descending order of their shares in percentage, and/or a minimum cut-off share percentage (e.g. 1%), thereby neglecting those providers of smallest shares to eliminate insignificant accesses or payment distribution. This helps to reduce the transmission and processing loads.

After the user's computer finishes generating the usage report, a much simplified (payment) distribution table as shown in FIG. 10 is extracted and transmitted to the system central site.

Different client programs will send their individual distribution tables to the central site at different times throughout the next billing period 2. The central site will integrate all the distribution tables received up to the end of the second period 2. The central site will subsequently produce a completely integrated payment table as shown in FIG. 11 for all the providers. This table contains the total amount (in %) that each provider should receive for the preceding first period 1, and will be delivered to the business operator for payment arrangement to the providers. The timeline of the payment process is shown in FIG. 4.

The metering of usage performed on the users' side is preferred. The calculation of total usage and the formation of distribution tables accomplished on the users' side are also preferred. With all such tasks assigned to the users' computers, the load of the central site server can be minimized. The central site server is mainly responsible for integrating the distribution tables received from the users, whereby its system requirements can be reduced or it can efficiently deal with a very large number of providers and users on an enormous scale. These advantages are enhanced by reason of the transmission and processing loads for consolidating and integrating usage and payment distribution being spread over the whole of the next billing period 2, or any predetermined interval following the last billing period.

The direct provision of products/services from the providers to the users (using Method 2) and usage metering at the users' side is advantageous to save system resources, because the users' accesses to the providers' sites are continuous and throughout the whole billing period. However, given that usage consolidation, calculation and integration only need to be performed once every billing period per user, it is possible to implement a system where usage consolidations and calculations, etc. are processed by the system server instead of the users' computers.

The central site will keep a copy of the distribution table for each user. If a user does not log onto the network for the whole of period 2, the usage data recorded on the central site (accessed by Method 1) will be used to calculate the payment distribution. If there is no usage data on the central site, the previous distribution table will be used to integrate into the current payment table. In doing so, all the providers participating the payment scheme will be paid to the total amount of all the user subscription fees received for the last billing period promptly.

The distribution table contains the percentage of subscription fee to be paid to the providers. This is to ensure easier processing should the business operator need to change subscription fee.

As schools, libraries, net cafes, corporations and governments would access products and services at a much higher volume, a relatively higher group subscription rate (fee) may be set for high volume users. To differentiate individual users from group users, there should be a practical usage limit for individual accounts. The usage limit should be several times higher than an average user's usage. This limit should be set and enforced by the business operator. The system operator will receive the distribution tables with total usage volume. If the limit is exceeded, the system operator will inform the business operator. It is the business operator's decision to deactivate the user or to persuade the user to switch to a group scheme. The group scheme is preferably implemented separately with a separate central site and settings, for scalability and for providers to choose what subscription rate (or scheme) to participate.

Product and service providers may participate in the subject payment scheme and at the same time implement their own subscription or access methods on the same network. Such users and providers participating in other schemes are not excluded from the scope of this patent. There may be many business and system operators on the same network, with each system operating independently of the other.

The invention has been given by way of example only, and various other modifications of and/or alterations to the described embodiment may be made by persons skilled in the art without departing from the scope of the invention as specified in the appended claims.

1. A payment distribution method for distributing payment to a plurality of product/service providers of a predetermined fee paid by a user using their products/services by means of a network access device on an electronic network over a predetermined billing period, comprising the steps of:
(1) setting up a system server and running a system program on the server;
(2) installing and running a client program on said user's network access device;
(3) recording data of usage of said products/services by said user, the data comprising at least one of the following usage elements: size of files accessed, number of files accessed, time spent on providers' sites, duration of download processes and number of download transmissions;
(4) calculating payment distribution to those providers provided products/services to said user over the billing period by dividing the user's fee into shares among them generally according to the usage element associated with each provider in relation to the total usage element associated with all providers; and
(5) Distributing calculated payments to said providers.

2. The payment distribution method as claimed in claim 1, wherein step (3) comprises recording the usage data on said network access device, if said user uses said products/services bypassing the system server.

3. The payment distribution method as claimed in claim 1, wherein step (3) comprises recording the usage data on the system server, if said user uses said products/services via the system server.

4. The payment distribution method as claimed in claim 1, wherein in step (3) the usage data is recorded on either one or both of the system server and the network access device, and step (3) includes consolidating the usage data recorded on the system server and the network access device to generate total usage data for calculation in step (4).

5. The payment distribution method as claimed in claim 4, wherein in step (3) the usage data is recorded on both the system server and the network access device, and the usage data is consolidated by the network access device, and in step (4) the payment distribution is calculated by the network access device.

6. The payment distribution method as claimed in claim 4, wherein in step (3) the usage data is recorded on the network access device, and in step (4) the payment distribution is calculated by the network access device.

7. The payment distribution method as claimed in claim 4, wherein in step (3) the usage data is recorded on both the system server and the network access device, and the usage data is consolidated by the system server, and in step (4) the payment distribution is calculated by the system server.

8. The payment distribution method as claimed in claim 1, wherein the distributed payments sum up substantially to the user's fee.

9. The payment distribution method as claimed in claim 1, wherein in step (4) the payment distribution is calculated using the follow formula:
$${P}_{i} = ( \frac{{x}_{i}}{X} ) {f}_{0} where {\sum }_{alli}^{} \frac{{x}_{i}}{X} = 1$$
fₒ=Predetermined fee paid by user
Pᵢ=Payment for distribution to provider i
xᵢ=Usage element of use by user for provider i
X=Usage element of use by user for all providers.

10. The payment distribution method as claimed in claim 9, wherein the formula is generalized to:
$${P}_{i} = ( {w}_{1} \frac{{x}_{i , 1}}{{X}_{1}} + {w}_{2} \frac{{x}_{1 , 2}}{{X}_{2}} + … + {w}_{j} \frac{{x}_{i , j}}{{X}_{j}} ) {f}_{0}$$
$$Where {\sum }_{allj}^{} {w}_{j} = 1 , {\sum }_{alli}^{} \frac{{x}_{i , j}}{{X}_{j}} = 1$$
x_{i,1} and X₁=size of files accessed from provider i and all providers respectively
x_{i,2} and X₂=number of files accessed from provider i and all providers respectively
x_{i,3} and X₃=time spent on sites of provider i and all providers respectively
x_{i,4} and X₄=duration of download processes from provider i and all providers respectively
x_{i,5} and X₅=number of download transmissions from provider i and all providers respectively
wⱼ=weighing factor ranging from 0 to 1 inclusive.

11. The payment distribution method as claimed in claim 1, wherein a plurality of said users are involved, with step (3) and step (4) taken for each of them, and step (4) includes subsequently integrating the calculated payments in relation to all the users.

12. The payment distribution method as claimed in claim 11, wherein in step (4) the calculated payments are integrated by the system server, and in step (5) the payments are distributed by the system server.

13. The payment distribution method as claimed in claim 5, wherein in step (3) the usage data is consolidated by the network access device during a predetermined interval following the billing period.

14. The payment distribution method as claimed in claim 5, wherein a plurality of said users are involved, with step (3) and step (4) taken for each of them, and step (4) includes subsequently transmitting the calculated payment distributions from the network access devices to the system server for integration thereby before taking step (5).

15. The payment distribution method as claimed in claim 14, wherein in step (4) the calculated payment distributions are transmitted from the network access devices to the system server over a predetermined interval following the billing period.

16. The payment distribution method as claimed in claim 15, wherein in step (3) the usage data is consolidated by the network access device during the same predetermined interval as that of step (4).

17. The payment distribution method as claimed in claim 6, wherein a plurality of said users are involved, with step (3) and step (4) taken for each of them, and step (4) includes subsequently transmitting the calculated payment distributions from the network access devices to the system server for integration thereby before taking step (5).

18. The payment distribution method as claimed in claim 17, wherein in step (4) the calculated payment distributions are transmitted from the network access devices to the system server over a predetermined interval following the billing period.

19. The payment distribution method as claimed in claim 1, wherein step (5) includes neglecting some of said providers of smallest shares in the calculated payment distribution.

20. The payment distribution method as claimed in claim 19, wherein step (5) includes setting a maximum number of providers per payment distribution in descending order of their shares to neglect those providers in excess of the number.

21. The payment distribution method as claimed in claim 19, wherein step (5) includes setting a minimum cut-off share percentage to neglect those providers of shares smaller than the cut-off percentage.

22. The payment distribution method as claimed in claim 1, including the following step between step (2) and step (3): (2A)registering each of said provider and user participating in the method and setting up an individual account therefor.

23. The payment distribution method as claimed in claim 22, being set up and operated by a system operator and run by a business operator who is only responsible for taking step (2A) and step (5).
